(19) United States
(12) Patent Application Publication
(10) Pub. No.: US 2023/0243912 A1
(43) Pub. Date: Aug. 3, 2023

(54) ANTENNA DEVICE

(71) Applicant: KABUSHIKI KAISHA TOKAI RIKA DENKI SEISAKUSHO, Aichi (JP)

(72) Inventors: Koji INAFUNE, Aichi (JP); Kenichi KOGA, Aichi (JP); Tatsuya KOIKE, Aichi (JP); Satoshi MORI, Aichi (JP); Yoshiki OISHI, Aichi (JP)

(73) Assignee: KABUSHIKI KAISHA TOKAI RIKA DENKI SEISAKUSHO, Aichi (JP)

(21) Appl. No.: 18/087,898

(22) Filed: Dec. 23, 2022

(30) Foreign Application Priority Data
Feb. 1, 2022 (JP) 2022-014205

(51) Int. Cl. G01S 5/02

(52) U.S. Cl. CPC G01S 5/02216; G01S 5/0284

(57) ABSTRACT

A positional relationship between devices that have transmitted and received signals is more accurately estimated.

An antenna device used for an arithmetic operation that is based on a signal received from a certain communication device, the antenna device comprising a first antenna, a second antenna, and a third antenna at positions meeting respective vertices of an equilateral triangle.

### CROSS REFERENCE TO RELATED APPLICATION(S)

This application is based upon and claims benefit of priority from Japanese Patent Application No. 2022-014205, filed on Feb. 1, 2022, the entire contents of which are incorporated herein by reference.

### BACKGROUND

The present invention relates to an antenna device.

In recent years, there is disclosed a technology that estimates a positional relationship between devices according to a result of transmission and reception of wireless signals between the devices. For example, WO 2015/176776 A discloses a technology that an Ultra Wide Band (UWB) receiver estimates an angle of incidence of a signal from a UWB transmitter by using a UWB signal.

### SUMMARY

However, according to the technology disclosed in above WO 2015/176776 A, an error is likely to occur in an arithmetic operation result depending on antenna positions and environment in which signals are transmitted and received when estimating a positional relationship between devices.

Therefore, the present invention has been made in light of the above problem, and an object of the present invention is to provide a new and improved antenna device that can more accurately estimate a positional relationship between devices that have transmitted and received signals.

To solve the above described problem, according to an aspect of the present invention, there is provided an antenna device used for an arithmetic operation that is based on a signal received from a certain communication device, the antenna device comprising a first antenna, a second antenna, and a third antenna at positions meeting respective vertices of an equilateral triangle.

As described above, the present invention can more accurately estimate a positional relationship between devices that have transmitted and received signals.

### BRIEF DESCRIPTION OF THE DRAWINGS

FIG. 1 is a block diagram illustrating an example of a configuration of a system according to an embodiment of the present invention.

FIG. 2 is a perspective view for explaining an example of a configuration of a communication section according to the present embodiment.

FIG. 3 is a longitudinal cross-sectional view for explaining an example of a configuration of the communication section according to the present embodiment.

FIG. 4 is an explanatory view for explaining an outline example of the system according to the present embodiment.

FIG. 5 is a sequence diagram for explaining an example of a process of inter-device positional relationship estimation executed by the system according to the present embodiment.

FIG. 6 is an explanatory view for specifically explaining a process of signal arrival angle estimation.

FIG. 7 is a view for explaining an example of an operation process of positional relationship estimation by the system according to the present embodiment.

### DETAILED DESCRIPTION OF THE EMBODIMENT(S)

Hereinafter, referring to the appended drawings, a preferred embodiment of the present invention will be described below in detail. It should be noted that, in this description and the appended drawings, components that have substantially the same function and configuration are denoted with the same reference numerals, and repeated explanation thereof is omitted.

Furthermore, in this description and the appended drawings, elements that have substantially the same function and configuration are distinguished by adding different alphabets or numbers to tails of identical reference numerals in some cases. For example, a plurality of elements having substantially identical functions and configurations are distinguished like antennas 221A, 221B, and 221C as needed. In this regard, each of the plurality of elements are assigned only identical reference numerals in a case where each of the plurality of elements including the substantially identical functions and configurations do not particularly need to be distinguished. For example, the antennas 221A, 221B, and 221C are referred to simply as antennas 221 in a case where the antennas 221A, 221B, and 221C do not particularly need to be distinguished.

### 1. Configuration Example

### 1.1. Configuration Example of System 1

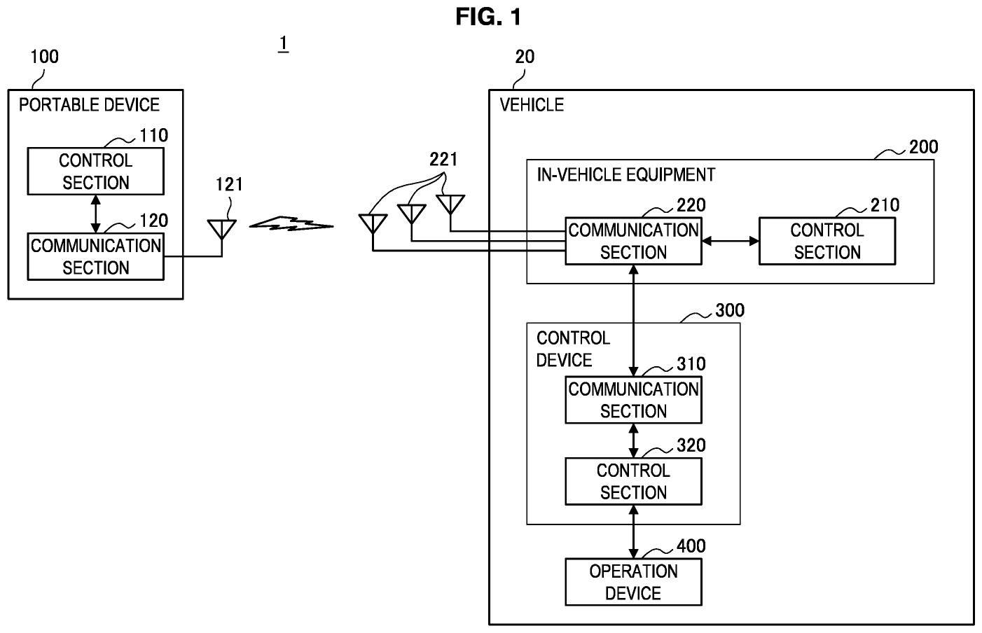

FIG. 1 is a block diagram illustrating an example of a configuration of a system 1 according to an embodiment of the present invention. As illustrated in FIG. 1, the system 1 according to the present embodiment includes a portable device 100, in-vehicle equipment 200, a control device 300, and an operation device 400.

The in-vehicle equipment 200, the control device 300, and the operation device 400 according to the present embodiment are mounted on, for example, a vehicle 20. The vehicle 20 is an example of a movable body, and is, for example, a vehicle (e.g., a vehicle owned by a user or a vehicle temporarily lent to the user) that the user is permitted to get on. Note that the movable body according to the present embodiment includes not only the vehicle 20, but also an airplane or a ship.

(Portable Device 100)

The portable device 100 is an example of another communication device, and is a device that is carried by the user who uses the vehicle 20. The portable device 100 may be an electronic key, a smartphone, a tablet terminal, a wearable terminal, and the like. As illustrated in FIG. 1, the portable device 100 includes a control section 110 and a communication section 120.

The control section 110 controls all operations of the portable device 100. The control section 110 causes the communication section 120 to transmit, for example, a Poll (Polling) signal described later. Furthermore, the control section 110 causes the communication section 120 to transmit a Final signal described later.

The control section 110 includes, for example, electronic circuits such as a Central Processing Unit (CPU) and a microprocessor.

The communication section 120 performs wireless communication with a communication section 220 included in the in-vehicle equipment 200. For example, the communication section 120 transmits the Poll signal according to control of the control section 110. Furthermore, the communication section 120 receives a Resp (Response) signal transmitted from the communication section 220 included in the in-vehicle equipment 200 as a response to the transmitted Poll signal. Furthermore, the communication section 120 transmits the Final signal as a response to the received Resp signal according to control of the control section 110.

Wireless communication between the communication section 120 and the communication section 220 included in the in-vehicle equipment 200 is expressed as, for example, a signal (expressed as a UWB signal below) that conforms to ultra wide band wireless communication. Using an impulse system for wireless communication that uses the UWB signal makes it possible to accurately measure an air propagation time of a radio wave by using a radio wave of a very short pulse width equal to or less than a nano second, and accurately perform positioning and distance measurement based on the propagation time. The communication section 120 is configured as a communication interface that can perform communication using, for example, a UWB signal.

Note that the UWB signal may be transmitted and received as a distance measurement signal and a data signal. The distance measurement signal is the Poll signal, the Resp signal, and the Final signal transmitted and received during a distance measurement process described later. The distance measurement signal may be configured in a frame format that does not include a payload part in which data is stored, or may be configured in a frame format that includes a payload part. On the other hand, the data signal is preferably configured in a frame format that includes a payload part in which data is stored.

Furthermore, wireless communication between the communication section 120 and the communication section 220 included in the in-vehicle equipment 200 is not limited to a UWB signal. For example, Blue Tooth (BT) communication and the like are applicable to the wireless communication between the communication section 120 and the communication section 220.

Furthermore, the communication section 120 includes at least one antenna 121. Furthermore, the communication section 120 transmits and receives a wireless signal via the at least one antenna 121.

(In-Vehicle Equipment 200)

The in-vehicle equipment 200 is a device that is mounted on the vehicle 20. As illustrated in FIG. 1, the in-vehicle equipment 200 includes a control section 210 and the communication section 220.

The control section 210 controls all operations of the in-vehicle equipment 200. The control section 210 causes the communication section 220 to transmit, for example, a Resp signal described later.

The control section 210 includes, for example, electronic circuits such as a CPU and a microprocessor.

The communication section 220 is an example of an antenna device that performs wireless communication with the communication section 120 included in the portable device 100. The communication section 220 receives a Poll signal transmitted from the communication section 120 included in the portable device 100. Furthermore, the communication section 220 transmits the Resp signal as a response to the received Poll signal according to control of the control section 210. Furthermore, the communication section 220 receives the Final signal transmitted from the communication section 120 included in the portable device 100 as a response to the transmitted Resp signal.

Furthermore, the communication section 220 includes the three antennas 221 as an example of a first antenna, a second antenna, and a third antenna. Furthermore, the communication section 220 transmits and receives wireless signals via the three or more antennas 221.

(Control Device 300)

The control device 300 is a device that controls all operations of the vehicle 20. For example, the control device 300 performs control of estimating a positional relationship between the portable device 100 and the in-vehicle equipment 200. As illustrated in FIG. 1, the control device 300 includes a communication section 310 and a control section 320.

Note that, although explanation on this description will describe an example where the vehicle 20 according to the present embodiment includes the in-vehicle equipment 200 and the control device 300 as separate components, the portable device 100 or the in-vehicle equipment 200 may realize functions of the control device 300.

The communication section 310 performs various types of communication with the in-vehicle equipment 200 by using an arbitrary communication system. For example, the communication section 310 receives information of signals transmitted and received between the portable device 100 and the in-vehicle equipment 200 from the communication section 220 included in the in-vehicle equipment 200. Note that the arbitrary communication system may be wired communication or may be wireless communication. Furthermore, the communication section 310 may perform various types of communication with the communication section 120 included in the portable device 100 by using a wireless communication system.

The control section 320 controls all operations of the control device 300. For example, the control section 320 performs an arithmetic operation that is based on a signal received from the portable device 100.

The control section 320 performs control of estimating the positional relationship between the portable device 100 and the in-vehicle equipment 200 as, for example, the arithmetic operation that is based on the signal received from the portable device 100.

Furthermore, the control section 320 estimates a signal arrival angle based on the signal received by the in-vehicle equipment 200 from the portable device 100. More specifically, the control section 320 estimates the signal arrival angle based on phase differences between antenna pairs of the three or more antennas included in the in-vehicle equipment 200.

Furthermore, the control section 320 estimates a distance measurement value that is a distance between the portable device 100 and the in-vehicle equipment 200 based on the signals transmitted and received between the portable device 100 and the in-vehicle equipment 200.

Furthermore, the control section 320 may control a predetermined operation of the operation device 400 based on the estimated distance measurement value and signal arrival angle.

The control section 320 includes, for example, electronic circuits such as a CPU and a microprocessor.

(Operation Device 400)

The operation device 400 is a device that operates according to control of the control device 300. The operation device 400 may be, for example, a key of doors included in the vehicle 20, or may be an engine included in the vehicle 20.

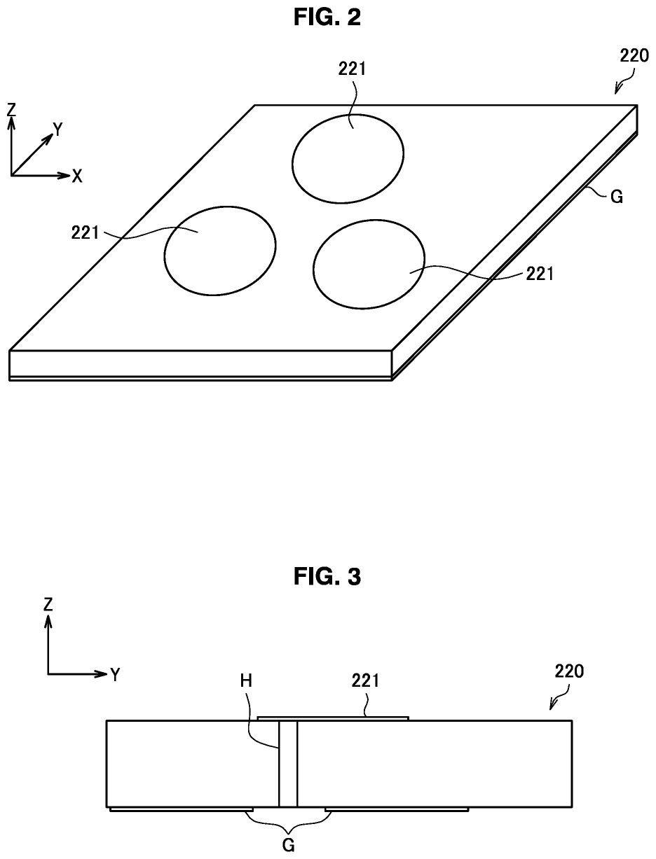

The configuration example of the system 1 according to the present embodiment has been described above. Next, a configuration of the communication section 220 included in the in-vehicle equipment 200 will be described with reference to FIGS. 2 and 3.

### 1.2. Configuration Example of Communication Section 220

FIG. 2 is a perspective view for explaining an example of the configuration of the communication section 220 according to the present embodiment. The communication section 220 according to the present embodiment includes the three antennas 221 on a dielectric substrate. For example, the antennas 221 may be Microstrip Antenna (MSA) elements and the like.

Furthermore, the three antennas 221 are arranged at positions meeting the respective vertices of the equilateral triangle. That is, the three antennas are arranged on the dielectric substrate such that distances between respective antenna pairs of the three antennas are the same or are substantially the same.

Note that each length of each side of the equilateral triangle is desirably a ½ wavelength or less. That is, the three antennas are arranged on the dielectric substrate such that the distance between each antenna pair of the three antennas 221 is the ½ wavelength or less.

Consequently, the control section 320 can estimate a signal arrival angle described below by using phase differences between three antenna pairs.

On the other hand, there is a case where the three antennas 221 are arranged at positions meeting three vertices of respective vertices of a square. In this case, it is difficult to make a distance between the two antenna pairs arranged on a diagonal line of the square the ½ wavelength or less.

In a case where the distance between the antenna pair exceeds the ½ wavelength, the control section 320 has difficulty in using the phase difference between this antenna pair for estimating the signal arrival angle.

That is, arranging the three antennas 221 at the positions meeting the respective vertices of the equilateral triangle as illustrated in FIG. 2 can increase an information amount used to estimate the signal arrival angle. As a result, the control section 320 can more accurately estimate the signal arrival angle. Details on estimation of the signal arrival angle based on the phase differences between the three antenna pairs will be described later.

Note that the following description will distinguish and explain the three antennas as the antenna 221A, the antenna 221B, and the antenna 221C.

Furthermore, the dielectric substrate according to the present embodiment is a substrate of a flat plate shape formed by a dielectric material. For example, the dielectric substrate may be a printed circuit board such as a paper phenol substrate, a paper epoxy substrate, or a glass epoxy substrate obtained by impregnating an organic resin in paper or a glass fiber cloth. Another example of the dielectric substrate may be a ceramic substrate formed by aluminium oxide or the like.

The antenna 221 may be provided on, for example, one face of the dielectric substrate. For example, the antenna 221 may be provided in a +z direction on the dielectric substrate as illustrated in FIG. 2.

Furthermore, the communication section 220 may include a ground G on a face on a side opposite to the face provided with the antenna 221. For example, the ground G may be provided in a −z direction on the dielectric substrate as illustrated in FIG. 2. Note that the ground G may be formed by a conductive material.

FIG. 3 is a longitudinal cross-sectional view for explaining an example of the configuration of the communication section 220 according to the present embodiment. For example, the communication section 220 includes a via hole H for conducting layers of the dielectric substrate as illustrated in, for example, FIG. 3. For example, the layers are conducted through the via hole H to cause the MSA elements to function as the antennas.

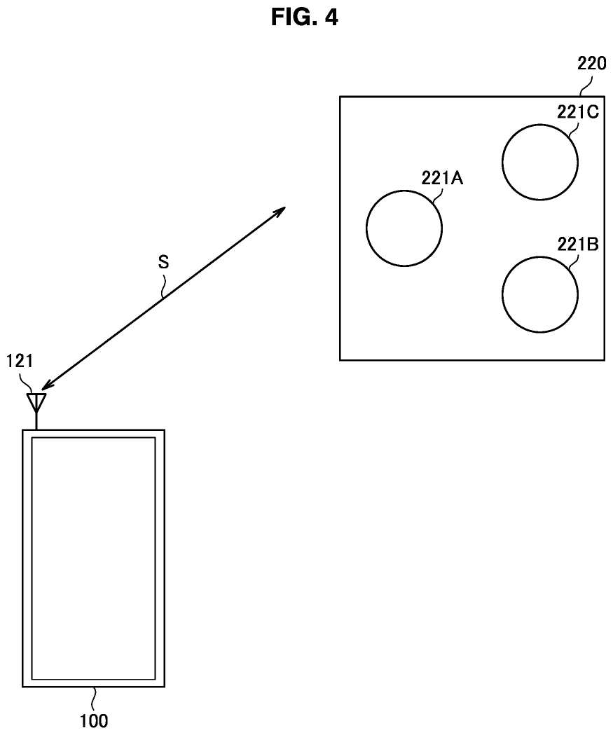

The configuration example of the communication section 220 has been described above. Next, technical features of the system 1 according to the present embodiment will be described with reference to FIGS. 4 to 6.

### 2. Technical Features

<2.1 Outline>

FIG. 4 is an explanatory view for explaining an outline example of the system 1 according to the present embodiment. The communication section 120 included in the portable device 100 includes the antenna 121 as illustrated in FIG. 4. Furthermore, the communication section 220 included in the in-vehicle equipment 200 includes, for example, the antenna 221A, the antenna 221B, and the antenna 221C as three element array antennas.

In this regard, the number of antennas included in the communication section 120 included in the portable device 100 is not limited to this example. For example, the number of the antennas 121 included in the communication section 120 may be plural.

Furthermore, a scale ratio of the communication section 220 and the plurality of antennas 221 included in the communication section 220 is not limited to an illustrated scale ratio.

Furthermore, in FIG. 4, the antenna 121 included in the portable device 100 is arranged at a left end on an upper side of the portable device 100. However, a position at which the antenna 121 included in the portable device 100 is arranged is not limited to this example. For example, the antenna 121 may be arranged at an arbitrary position of the portable device 100.

As illustrated in FIG. 4, for example, the antenna 121 may transmit and receive a signal S to and from at least one or more antennas of the plurality of antennas 221 included in the communication section 220.

Furthermore, the communication section 310 included in the control device 300 receives information related to the signal S transmitted and received between the portable device 100 and the in-vehicle equipment 200 from one of the communication section 120 and the communication section 220.

Then, the control section 320 included in the control device 300 may estimate the positional relationship between the portable device 100 and the in-vehicle equipment 200 based on the transmitted and received signal S.

Next, a specific example of a process of estimating the positional relationship between the portable device 100 and the in-vehicle equipment 200 according to the present embodiment will be described.

<2.2. Positional Relationship Estimation>

(1) Distance Estimation

The control section 320 performs a distance measurement process. The distance measurement process is a process of estimating a distance between the portable device 100 and the in-vehicle equipment 200. The distance measurement process includes transmitting and receiving a distance measurement signal, and estimating a distance, i.e., a distance measurement value between the portable device 100 and the in-vehicle equipment 200 based on a time taken to transmit and receive the distance measurement signal.

According to the distance measurement process, a plurality of distance measurement signals can be transmitted and received between the portable device 100 and the in-vehicle equipment 200. A distance measurement signal transmitted from one device to an other device among the plurality of distance measurement signals will be referred to as a Poll signal.

Furthermore, a distance measurement signal transmitted from the device that has received the Poll signal as a response to the Poll signal to the device that has transmitted the Poll signal will be referred to as a Resp signal.

Furthermore, a distance measurement signal transmitted from the device that has received the Resp signal as a response to the Resp signal to the device that has transmitted the Resp signal will be referred to as a Final signal. Although the portable device 100 and the in-vehicle equipment 200 can transmit and receive any distance measurement signals, this description will describe an example where the portable device 100 transmits the Poll signal.

(2) Arrival Angle Estimation

The control section 320 estimates an arrival angle of a signal transmitted and received between the devices. This description will describe the Final signal included in the distance measurement signal as a signal for arrival angle estimation.

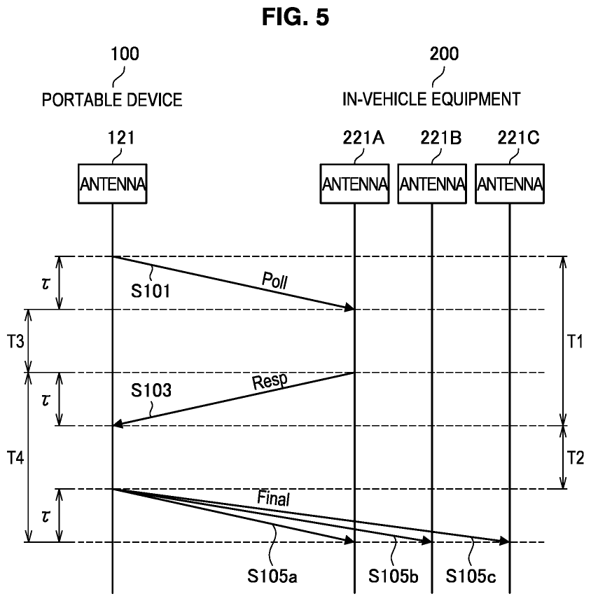

Hereinafter, an example of processes of distance estimation and arrival angle estimation will be described with reference FIG. 5.

FIG. 5 is a sequence diagram for explaining an example of the process of inter-device positional relationship estimation executed by the system 1 according to the present embodiment.

First, the antenna 121 included in the portable device 100 transmits a Poll signal to the antenna 212A included in the in-vehicle equipment 200 (S101).

Next, the antenna 221A included in the in-vehicle equipment 200 transmits a Resp signal as a response to the Poll signal to the antenna 121 included in the portable device 100 (S103).

Furthermore, the antenna 121 included in the portable device 100 transmits a Final signal as a response to the Resp signal to the antenna 221A, the antenna 221B, and the antenna 221C included in the in-vehicle equipment 200 (S105).

In this regard, a time length taken by the portable device 100 to receive the Resp signal after transmitting the Poll signal is a time length T1, and a time length taken by the portable device 100 to transmit the Final signal after receiving the Resp signal is a time length T2. Furthermore, a time length taken by the in-vehicle equipment 200 to transmit the Resp signal after receiving the Poll signal is a time length T3, and a time length taken by the in-vehicle equipment 200 to receive the Final signal after transmitting the Resp signal is a time length T4.

The distance between the portable device 100 and the in-vehicle equipment 200 may be calculated by using each of the above-described time lengths. For example, the in-vehicle equipment 200 may receive a signal including information related to the time length T1 and the time length T2 from the portable device 100.

Next, the control device 300 may receive a signal including information related to the time length T1, the time length T2, the time length T3, and the time length T4 from the in-vehicle equipment 200.

Furthermore, the control section 320 calculates a signal propagation time τ by using the time length T1, the time length T2, the time length T3, and the time length T4. More specifically, the control section 320 may calculate the signal propagation time τ by using following equation 1.

τ=(T1×T4−T2×T3)/(T1+T2+T3+T4) (Equation 1)

Furthermore, the control section 320 may estimate the distance between the portable device 100 and the in-vehicle equipment 200 by multiplying the calculated signal propagation time τ with a known signal speed.

Note that an example where the control section 320 estimates the distance between the portable device 100 and the in-vehicle equipment 200 based on the signals transmitted and received between the antenna 121 included in the portable device 100 and the antenna 221A included in the in-vehicle equipment 200 has been described. However, the in-vehicle equipment 200 may transmit and receive the signals by using an antenna different from the antenna 221A, or may transmit and receive the signals by using the plurality of antennas 221.

Furthermore, the signal propagation time τ is not limited to a calculation method expressed by equation 1. For example, the signal propagation time τ can be calculated by subtracting the time length T3 from the time length T1, and dividing a resulting time by 2.

Next, a signal arrival angle may be calculated from phase differences between respective antenna pairs of the Final signals received by the plurality of antennas 221 included in the in-vehicle equipment 200.

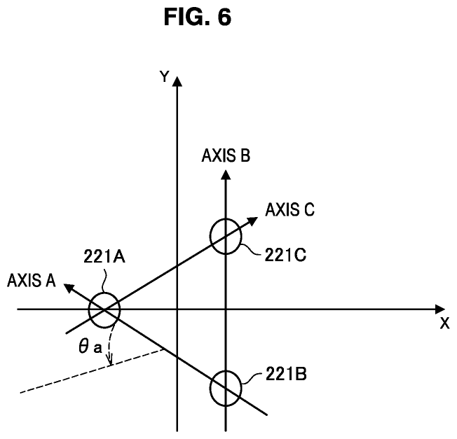

FIG. 6 is an explanatory view for explaining a specific example of a process of signal arrival angle estimation. For example, a phase of the Final signal received by the antenna 221A is a phase P_{A}, a phase of the Final signal received by the antenna 221B is a phase P_{B}, and a phase of the Final signal received by the antenna 221C is a phase P_{C}.

For example, a straight line that connects the antenna 221A and the antenna 221B is an axis A, a straight line that connects the antenna 221B and the antenna 221C is an axis B, and a straight line that connects the antenna 221A and the antenna 221C is an axis C.

Furthermore, a coordinate system in which a direction parallel to the axis B is a Y axis, and a direction perpendicular to the Y axis is an X axis is defined.

In a case of this coordinate system, phase differences Pd_{AB}, Pd_{BC}, and Pd_{AC} between antenna pairs are each expressed by using following equation 2.

Pd_{AB}=(P_{A} P_{B})

Pd_{BC}=(P_{B} P_{C})

Pd_{AC}=(P_{A} P_{C}) (Equation 2)

In this regard, angles formed by the axis A, the axis B, and the axis C, and the signal are referred to as formed angles θ. In this regard, the formed angles θ are signal arrival angles, and are each expressed by equation 3. Note that λ represents a wavelength of a radio wave, and d represents a distance between the antennas.

θ=arccos(λ×Pd/(2πd)) (Equation 3)

Accordingly, the control section 320 calculates each of the signal arrival angles according to equation 4 based on equation 2 and equation 3. Note that θa represents the signal arrival angle with respect to the axis A, θb represents the signal arrival angle with respect to the axis B, and θc represents the signal arrival angle with respect to the axis C.

θa=θ_{AB}=arccos(λ×(P_{A}−P_{B})/(2πd))

θb=θ_{BC}=arccos(λ×(P_{B}−P_{C})/(2πd))

θc=θ_{AC}=arccos(λ×(P_{A}−P_{C})/(2πd)) (Equation 4)

Furthermore, the control section 320 may estimate the positional relationship between the portable device 100 and the in-vehicle equipment 200 based on the respective signal arrival angles with respect to the axis A, the axis B, and the axis C, and a distance measurement value.

Furthermore, when the signal arrival angles or the distance measurement value satisfy a predetermined criterion, the control section 320 may control a predetermined operation of the operation device 400.

### 3. Operation Process Example

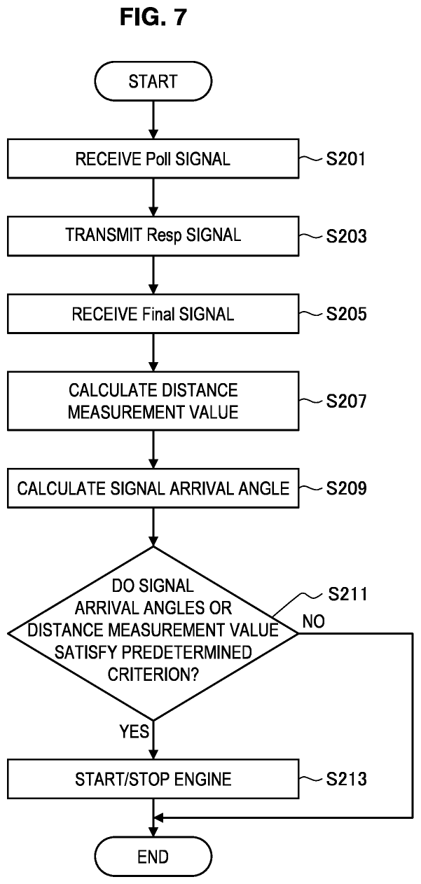

FIG. 7 is a view for explaining the example of an operation process of positional relationship estimation of the system 1 according to the present embodiment. First, the communication section 120 included in the portable device 100 transmits a Poll signal, and the communication section 220 included in the in-vehicle equipment 200 receives the Poll signal (S201).

Next, the communication section 220 transmits a Resp signal as a response to the Poll signal, and the communication section 120 receives the Resp signal (S203).

Furthermore, the communication section 120 transmits a Final signal as a response to the Resp signal, and the communication section 220 receives the Final signal (S205). In this regard, the communication section 220 transmits various pieces of information related to the signals transmitted and received to and from the communication section 120, to the communication section 310 included in the control device 300.

Next, the control section 320 calculates a distance measurement value based on the signals transmitted and received between the portable device 100 and the in-vehicle equipment 200 (S207).

Next, the control section 320 estimates an arrival angle of the signal received from the portable device 100 based on phase differences between antenna pairs (S209).

Furthermore, the control section 320 decides whether or not the signal arrival angle or the distance measurement value estimated per antenna pair satisfies the predetermined criterion (S211). In a case where it is decided that the predetermined criterion is satisfied (S211/Yes), the process proceeds to S213, and, in a case where it is decided that the predetermined criterion is not satisfied (S211/No), the control section 320 ends the process.

In the case where the predetermined criterion is satisfied (S211/Yes), the control section 320 performs operation control of starting or stopping an engine that is an example of the operation device 400 (S213), and the control section 320 ends the process.

The arrangement of the antennas 221 of the communication section 220 according to the above-described present embodiment increases an information amount that can be used to estimate signal arrival angles. As a result, for example, the control section 320 can more accurately estimate the positional relationship between the portable device 100 and the in-vehicle equipment 200.

### 4. Supplementary Explanation

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

Furthermore, a series of processes of each device described in this description may be realized by using one of software, hardware, and a combination of the software and the hardware. Programs that configure the software are stored in advance in, for example, recording media (non-transitory media) provided inside or outside each device. Furthermore, each program is read on a RAM when, for example, executed by a computer, and is executed by a processor such as a CPU. The above recording media are, for example, a magnetic disk, an optical disk, a magneto-optical disk, and a flash memory. Furthermore, the above computer programs may be distributed via, for example, a network without using the recording media.

Furthermore, the steps of the process of the operation of the system 1 according to the present embodiment do not necessarily need to be processed in chronological order in order described in the explanatory view. For example, each step of the process of the operation of the system 1 may be processed in order different from the order described in the explanatory view, or may be processed in parallel.

What is claimed is:

1. An antenna device used for an arithmetic operation that is based on a signal received from a certain communication device, the antenna device comprising a first antenna, a second antenna, and a third antenna at positions meeting respective vertices of an equilateral triangle.

2. The antenna device according to claim 1,
wherein a length of each side of the equilateral triangle is a ½ wavelength or less.

3. The antenna device according to claim 2,
wherein the arithmetic operation based on the received signal includes an arithmetic operation of estimating a positional relationship between the antenna device and the communication device.

4. The antenna device according to claim 3,
wherein the arithmetic operation of estimating the positional relationship includes an arithmetic operation of estimating an arrival angle of the signal.

5. The antenna device according to claim 4,
wherein the arrival angle of the signal is estimated based on an inter-antenna phase difference between the first antenna and the second antenna, an inter-antenna phase difference between the second antenna and the third antenna, and an inter-antenna phase difference between the first antenna and the third antenna.

6. The antenna device according to claim 1,
wherein the signal includes a wireless signal that conforms to ultra wide band communication.

7. The antenna device according to claim 1,
wherein the antenna device is mounted on a movable body.

8. The antenna device according to claim 7,
wherein the communication device is carried by a user who uses the movable body.
